(19) United States
(12) Patent Application Publication
(10) Pub. No.: US 2021/0071890 A1
(43) Pub. Date: Mar. 11, 2021

(54) METHOD FOR CONTROL OF A VENTILATION HEAT PUMP

(71) Applicant: ROMY CLIMA AS, Stjørdal (NO)

(72) Inventor: ROAR MYHRE, Dyvasåsen (NO)

(21) Appl. No.: 17/053,308

(22) PCT Filed: May 10, 2019
(86) PCT No.: PCT/NO2019/050104

§ 371 Date: Nov. 5, 2020

(30) Foreign Application Priority Data
May 15, 2018 (NO) 20180682

(51) Int. Cl. F24F 11/41; F24F 11/70; F24F 11/74; F24F 12/00; F24F 13/10; F24F 13/22; F24F 1/022; F24F 3/06

(52) U.S. Cl. CPC F24F 11/41; F24F 11/70; F24F 11/74; F24F 12/003; F24F 2110/10; F24F 13/222; F24F 1/022; F24F 3/065; F24F 13/10

(57) ABSTRACT

Method for control of a ventilation heat pump (10), comprising the steps: to measure the pressure drop over an evaporator (KF2) by the use of a pressure transmitter (PV1) during operation of the ventilation heat pump (10) to determine the need for defrosting, and by registering an increased pressure drop by the pressure transmitter (PV1) above a predetermined threshold value, the defrosting sequence is started. The defrosting sequence comprises the steps: stop the compressor (12) of the ventilation heat pump (10), reduce the power level to the exhaust fan (V2) and air supply fan (V1) to a level which is lower than for normal operation, shut the damper (S3) for external air to the evaporator (KF2), shut the damper (Si) for fresh air to the condenser (KF1), and set the damper (S2) for the return air to the evaporator (KF2) to lead return air to the evaporator (KF2), in which, during the defrosting sequence, energy from the return air is used for the defrosting of the evaporator (KF2), and also that circulation of a given volume of recirculated air is maintained.

### FIELD OF THE INVENTION

The present invention relates to a method for control of a ventilation heat pump, said ventilation heat pump comprises several dampers, fans, an evaporator/condenser, air mass regulators, temperature sensors, air filters, pressure transmitters and also at least one compressor, cooling tubes, a branch valve and a choke valve associated with the compressor.

### BACKGROUND OF THE INVENTION

In connection with defrosting, traditional ventilation heat pumps, in the main, have two alternatives, namely to either turn the cooling circuit by stopping the fan from working and taking the energy out of the exhaust air (recirculated air) in the condenser. But then the temperature in the supplied air will fall many degrees or stop the compressor and the fans/air stream and use the electrical heating element that is fitted in the evaporator and defrost by increasing the temperature in the evaporator.

### DESCRIPTION OF PRIOR ART

WO2014002357 A1 describes a defrosting function comprised of stopping the compressor and closing the damper.

EP2757327 A1 describes a defrosting function where the compressor is stopped, and a ventilation channel is closed with the help of a damper.

WO2017203680 A1 describes an air conditioning system where a damper for outlet air is closed in connection with defrosting.

US2014260368 A1 relates to a heat pump system where parts of the system are closed with the help of a damper for defrosting.

JP2009250464 A describes defrosting of a ventilation installation by closing a damper.

EP3086060 A1 shows use of a pressure sensor for measuring of the differential pressure over an evaporator.

US2005262853 A1 describes detection of ice formation in an evaporator by measuring of the pressure drop in the airstream.

US2007006600 A1 relates to estimation of the flow velocity from pressure measurements and the use of this to start the defrosting.

U.S. Pat. No. 2,975,611 A shows the use of a pressure sensitive switch for control of defrosting.

Reference is also given to US 2016252290 A1 and NO 20130573 A1 as examples of prior art.

### Objects of the Present Invention

The invention relates to a method and function for defrosting a ventilation heat pump. In the defrosting the heat pump compressor is stopped, exhaust fan and supply air fan are reduced by for example, 50%, and also that the damper for external air to the evaporator and fresh air to the condenser, respectively, are closed. The need for defrosting is detected by the help of one or more pressure sensors that measure the drop in pressure over the heat pump evaporator.

Damper control is used to control/move/close the air in the aggregate, this because one uses the temperature of for example, 50%, airmass of heated room air as a fan (at for example 50% power) pulls from a heated room to defrost the evaporator with the energy from the exhaust air back to the room and in addition the supplied air will (at example 50% power) pull about 50% of the exhaust air up to the room. This is to prevent stopping of the air stream from the installation and to reduce the experience of defrosting and air stream (recirculated air) to the room is reduced by about 50%, but does not stop. Other %-age advantages can also be used.

It is also possible to insert an electric battery that is controlled by the supply air temperature in the automatics after the condenser to maintain the supply air temperature during the defrosting.

With the invention a ventilation heat pump is provided which uses the energy from the exhaust air instead of turning the cooling circle during the defrosting and which maintains a “fixed” volume of air during the defrosting.

### SUMMARY OF THE INVENTION

The above mentioned objects are achieved with a method for control of a ventilation heat pump, said ventilation heat pump comprises several dampers, fans, an evaporator/condenser, air volume regulators, temperature sensors, air filters, pressure transmitters, and also at least one compressor, cooling tubes, a branch valve and a choke valve connected with the compressor, where the method comprises the steps:
measure the pressure drop over the evaporator by the use of a pressure transmitter during the operation of the ventilation heat pump to determine the need for defrosting,
with the registration of an increased pressure drop by the pressure transmitter over a predetermined threshold value, the defrosting sequence is starting comprising the steps:
the ventilation heat pump compressor is stopped,
the power level for exhaust air fan and supplied air fan is reduced to a level lower than for normal operation,
the damper for external air to the evaporator is closed,
the damper for fresh air to the condenser is closed, and
the damper for return air to the evaporator is set to lead return air to the evaporator,
in which energy from the return air, during the defrosting sequence, is used for the defrosting of the evaporator, and also the circulation of a given volume of recirculated air is maintained.

The defrosting sequence can be driven until it is registered that the pressure drop is less than the predetermined threshold value. Alternatively, the defrosting sequence can be driven independently by a time switch.

The power level to the exhaust fan and the supply air fan can, during the defrosting sequence, be reduced to a set point for the volume of recirculated air of 50% of normal operation. The exhaust fan and supply air fan can, during the defrosting sequence, also reduce the volume of recirculated air to about 50% of normal operation.

The supply air fan can function as a recirculation fan during the defrosting sequence.

After the defrosting sequence has been completed, the ventilation heat pump can be started for normal operation in that the damper for external air to the evaporator is opened, the compressor is started, the damper for fresh air to the condenser is opened, the damper for return air to the evaporator is set to lead return air to the evaporator, the power level to the exhaust fan is increased to the set point for the volume of air used normally, and the power level to the air supply fan is increased to the set point for the volume of air for normal operation.

The pressure transmitter can be fitted to the inlet side and outlet side of the evaporator to measure the pressure drop over the evaporator.

To prevent a stoppage of the airstream from the ventilation heat pump during the defrosting, the air circulation can be reduced by 50% in that the damper control is used to control air in the ventilation heat pump, where energy in 50% volume of air of heated room air is used to fan at 50% power level which pulls from the heated room to defrost the evaporator.

The supply air fan can be driven at 50% power and pull 50% of the return air back to the room that shall be heated up.

Furthermore, an electric battery which is controlled by the supply air temperature in the automatics after the condenser can be used to maintain the supply air temperature during the defrosting.

About 50% of the heated room air can be sent back to the room as recirculated air through the condenser, the electric battery and the supply air fan.

In connection with the defrosting sequence, the draining can be carried out by a drain of moisture from the air in the condenser in heating mode and from the evaporator in cooling mode, where the draining from the condenser and evaporator are coupled together to a common water lock with outlets out to the waste side/air inlet side.

### DESCRIPTION OF THE FIGURES

Preferred embodiments of the invention shall be described in more detail in the following with reference to the enclosed FIGURE, in which:

FIG. 1 shows a principle diagram of a ventilation heat pump for use in the invention.

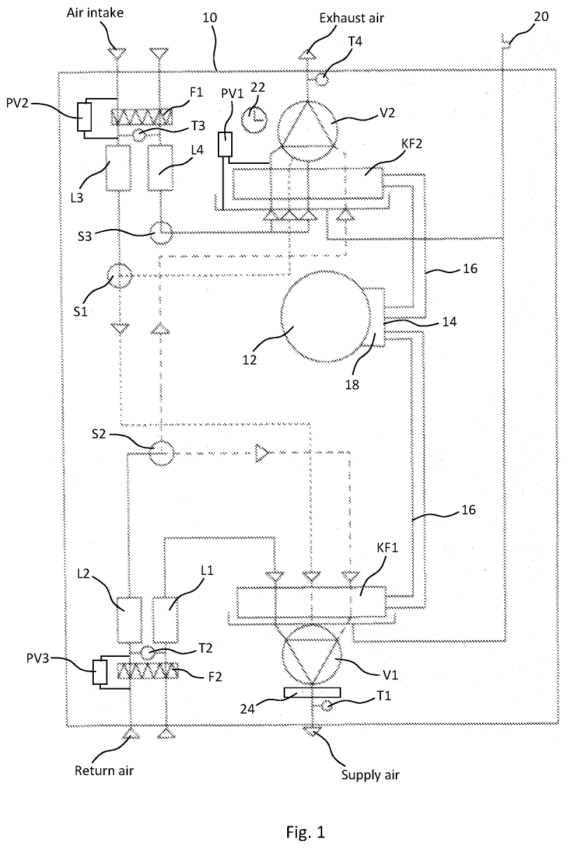

### DESCRIPTION OF PREFERRED EMBODIMENTS OF THE INVENTION

The ventilation heat pump 10, which is used in the invention, is a ventilation heat pump that can ventilate and give a balanced ventilation or air recirculation with heating and cooling of the rooms it is connected to by ventilation channels.

The rooms and ventilation channels are not shown as these are not essential for the invention and furthermore, it is known to a person skilled in the art that the design can vary from building to building.

Main components in the ventilation heat pump 10:
12—compressor
14—choke valve
16—cooling pipe
18—branch valve, for example a four-way valve
20—drainage
22—time switch
24—battery
F1-F2—air filters
T1-T4—thermistors, temperature sensors
L1-L4—air volume regulators (CAV)
S1-S3—damper with motors
V1-V2—fan with motors
KF1-KF2—condenser/evaporator
PV1-PV3—pressure transmitters

The ventilation heat pump 10 thus comprises, in one embodiment, several dampers S1-S3, fans V1-V2, condenser/evaporator KF1-KF2, air volume regulators L1-L4, temperature sensors T1-T4, air filters F1-F2, pressure transmitters PV1-PV3 and also at least one compressor 12, several cooling tubes 16, a branch valve 18 and a choke valve 14 connected with the compressor 12.

The pressure transmitters PV2-PV3 are, in the main, used as filter guards for the air filters F1-F2 for air supply and return air, respectively, and which give a signal when the pressure drop over the filters is too high (dirty) and must be changed.

The invention relates, in the main, to the function for defrosting of the ventilation heat pump 10. In the defrosting, the heat pump compressor 12 is stopped, the exhaust fan and supply air fans V1,V2 are reduced to about 50% power, and also that at least the dampers S3,S1 for external air to the evaporator KF2 and fresh air to the condenser KF1, respectively, are shut. The need for defrosting is detected with the help of a pressure sensor PV1 that measures the pressure drop over the evaporator KF2.

The ventilation heat pump 10 can be operated with a start/stop function and/or with time control in the form of a timer or time switch 22. With a damper function, the ventilation heat pump 10 is operated as a ventilation heat pump with air exchanging in the rooms it is connected to, and/or is operated as a pure heat pump without exchanging of the air (recirculated air). The operating mode can be chosen and controlled with a timer control, a movement sensor or a CO2 measuring unit.

Such a solution leads to optimal operation and energy saving, as the rooms can be controlled according to need with air exchange when the load from the rooms materialises.

Operation of the ventilation heat pump and the defrosting sequence comprises in the main three steps.

In a first step the pressure transmitter PV1 will warn when the pressure drop over the evaporator is too large, i.e. at the registering of an increased pressure drop by the pressure transmitter PV 1 over a predetermined threshold value, the defrosting sequence is started. The defrosting sequence can be operated until it is registered that the pressure drop has fallen below the predetermined threshold value, or the defrosting sequence can be operated dependent on a time switch 22, where the time switch 22 can be integrated in the automatics in or to the evaporator KF2.

In a second step, the volume of air and revolutions of the exhaust fan V2 and air supply fan V1 are reduced. The power level to the exhaust fan V2 and the supply air fan V1 can, during the defrosting sequence, be reduced to about half the normal operation, i.e. for example to a set point for the volume of air of 50% of normal operation. The air supply fan V1 can then function as a recirculating air fan.

Furthermore, the ventilation heat pump compressor 12 is stopped. The damper S3 for external air to the evaporator KF2 is closed, the damper S1 for fresh air to the condenser KF1 is closed and the damper S2 for return air to the evaporator KF2 is set to lead the return air to the evaporator KF2.

Drainage from the evaporator KF2 and the condenser KF1 can be achieved with drainage of moisture from the air in the condenser KF1 in heating mode and from the evaporator KF2 in cooling mode, where the drainage from the condenser KF1 and the evaporator KF2 is coupled together to a common water lock and with an outlet 20 out to the exhaust side/air intake side.

During the defrosting sequence energy from the return air is preferably used for the defrosting of the evaporator KF2, and also that the circulation of a given volume of recirculated air is maintained.

An electric battery 24 which is controlled by the supply air temperature in the automatics after the condenser KF1 can be used to maintain the supply air temperature during the defrosting, where about 50% of the heated room air can be sent back to the room as recirculated air through the condenser KF1, the electric battery 24 and the supply air fan V1.

In a third step the defrosting sequence is terminated. This is activated when the time switch 22 has run out of time or a lower pressure drop is registered and the evaporator KF2 is defrosted and the drained water has been disposed of.

The ventilation heat pump 10 is then started for normal operation in that the damper S3 for external air to the evaporator KF2 is opened, the damper S1 for fresh air to the condenser KF1 is opened and the compressor 12 is started. Furthermore, the damper S2 is set for return air to the evaporator KF2 to lead return air to the evaporator KF2 such that the installation is placed in ventilation mode. The fans V2 and V1 are adjusted to normal operation and revolutions in that the power level to the exhaust valve V2 is increased to the set point for the volume of air for normal operation and the power level to the air supply fan V1 is increased to the set point for the volume of air for normal operation.

The ventilation heat pump 10 can be operated with air exchanging, where the damper S1 is open, the damper S2 is open with the air direction towards the evaporator KF2 and the damper S3 is open. The fans V1 and V2 are in normal operation.

The ventilation heat pump 10 can also be operated without air exchanging, where the damper S1 is shut, the damper S2 is open with the air direction toward the condenser KF1 and the damper S3 is open.

1-13. (canceled)

14. A method for controlling a ventilation heat pump, wherein said ventilation heat pump comprises several dampers (S1-S3) and fans (V1-V2), a condenser and an evaporator (KF1-KF2), air volume regulators (L1-L4), temperature sensors (T1-T4), air filters (F1-F2), pressure transmitters (PV1-PV3) and at least one compressor, cooling tubes, a branch valve and a choke valve connected with the compressor, wherein the method comprises the steps:
measuring pressure drop over an evaporator (KF2) using a first pressure transmitter (PV1) during operation of the ventilation heat pump to determine the need for defrosting, and
when registering increased pressure drop by the first pressure transmitter (PV1) over a predetermined threshold value, starting a defrosting sequence comprising the steps:
stopping the compressor,
reducing power level to an exhaust fan (V2) and a supply air fan (V1) to a level which is lower than for normal operation,
shutting an external air damper (S3) supplying external air to the evaporator (KF2),
shutting a fresh air damper (S1) supplying fresh air to a condenser (KF1), and
setting a return air damper (S2) for return air to the evaporator (KF2) to lead return air to the evaporator (KF2), in which
during the defrosting sequence, using energy from the return air for defrosting of the evaporator (KF2), and
maintaining circulation of a given volume of recirculated air.

15. The method according to claim 14, wherein the method comprises the step of running the defrosting sequence until it is registered that the pressure drop has fallen below the predetermined threshold level.

16. The method according to claim 14, wherein the method comprises the step of running the defrosting sequence dependent of a time switch.

17. The method according to claim 14, wherein the method comprises the step of reducing the power level to the exhaust fan (V2) and the air supply fan (V1) during the defrosting sequence to a set point for air volume of recirculated air to about 50% of normal operation.

18. The method according to claim 14, wherein the power level to the exhaust fan (V2) and the air supply fan (V1) during the defrosting sequence reduces the volume of recirculated air to about half the volume during normal operation.

19. The method according to claim 14, wherein the method comprises the step of using the supply air fan (V1) during the defrosting sequence as a recirculating air fan.

20. The method according to claim 14, wherein the method comprises the steps of starting the ventilation heat pump for normal operation after the defrosting sequence is completed, by:
opening the external air damper (S3) for external air to the evaporator (KF2),
starting the compressor,
opening the fresh air damper (S1) for fresh air to the condenser (KF1),
setting the return air damper (S2) for return air to the evaporator (KF2) to lead return air to the evaporator (KF2),
increasing the power level to the exhaust fan (V2) to the set point for the volume of air during normal operation,
increasing the power level to the supply air fan (V1) to the set point for the volume of air at normal operation.

21. The method according to claim 14, wherein the pressure transmitter (PV1) is fitted to the inlet side and the outlet side of the evaporator (KF2) to measure the pressure drop over the evaporator (KF2).

22. The method according to claim 14, wherein, to prevent stopping the air stream from the ventilation heat pump during the defrosting, reducing the air circulation to 50% by using damper control to lead air in the ventilation heat pump, where energy in 50% of the volume of heated room air is used to the exhaust fan (V2) at 50% power pulled from the heated room to defrost the evaporator (KF2).

23. The method according to claim 22, wherein the supply air fan (V1) is run on 50% power and pulls 50% of the return air back to the room that shall be heated.

24. The method according to claim 23, in which 50% of the heated room air is sent back to the room as recirculated air through the condenser (KF1), the electric battery (24) and the supply air fan (V1).

25. The method according to claim 14, in which an electric battery which is controlled by the air supply temperature in the automatics after the condenser (KF1) is used to maintain the air supply temperature during the defrosting.

26. The method according to claim 25, in which 50% of the heated room air is sent back to the room as recirculated air through the condenser (KF1), the electric battery (24) and the supply air fan (V1).

27. The method according to claim 14, in which drainage is carried out by run off of moisture from air in the condenser (KF1) in heating mode and from the evaporator (KF2) in cooling mode, where drainage from the condenser (KF1) and evaporator (KF2) is coupled together to a common water lock and with outlets to the exhaust side/air inlet side.
